(19) United States
(12) Patent Application Publication
(10) Pub. No.: US 2013/0068489 A1
(43) Pub. Date: Mar. 21, 2013

(54) Method And Apparatus For Maintaining Farm Implement Level Throughout Vertical Range Of Motion

(71) Applicants: Tim Blunier, Danvers, IL (US); Michael G. Kovach, Morton, IL (US)

(72) Inventors: Tim Blunier, Danvers, IL (US); Michael G. Kovach, Morton, IL (US)

(21) Appl. No.: 13/237,208

(22) Filed: Sep. 20, 2011

(51) Int. Cl. A01B 63/10

(52) U.S. Cl. 172/239

(57) ABSTRACT

The present invention provides an operator-controllable system that allows the operator to make initial (and preferably optimal) field operation settings for the towed working tool (“implement”) quickly and easily when hitching the working tool to the towing vehicle, e.g., tractor. Once an initial setup is completed, in operation, the invention, which in one form is a leveling arrangement for the working tool, automatically maintains the optimal operation settings throughout the vertical operational range of the working tool. For example, if the optimal operation settings is a level implement throughout its operating range, the leveling arrangement will maintain the implement level as the implement is raised and lowered.

### BACKGROUND OF THE INVENTION

The present invention relates generally to industrial equipment, e.g., farm and construction equipment, and more particularly, to a method and apparatus for maintaining a working tool level throughout a vertical range of motion.

One of the keys to optimum performance of tillage equipment is the proper initial setting for field operation, which begins with leveling the implement (“working tool”) longitudinally (along the direction of travel) and laterally (across the implement width). To complicate matters in achieving this initial setting longitudinally, different tractor manufacturers utilize different draw bar heights to optimize their pull point for specific models. Different diameter tires used to meet specific farmer needs cause additional variances in draw bar height. No tillage implement manufacturer has a clear and simple means to accomplish machine leveling, which usually means a tractor driver and field observer are necessary to achieve proper setting.

Traditionally, to level a tillage implement laterally, one would use mechanical depth collars to restrict lift cylinder movement in the operating position. Although a positive means of controlling depth, depth collars are time consuming, as they require the operator to vacate the operator cab of the tractor and place the same size stop on all lift cylinder locations.

Another traditional method of accommodating various tractor draw bar heights on many machines is to provide multiple holes in which a hitch may be bolted. While this offers an economical method, it is time consuming and requires substantial effort to fine tune, requiring jacking up the implement, unhitching the tractor, removing and repositioning the hitch, then reconnecting the hitch. Also, the machine can only be properly set for a single depth and therefore precludes running the machine at varying depths without adjustment. This design also results in the front components of the machine to have less vertical clearance during transport situations.

Moreover, modern self-leveling mechanisms are intended to maintain implement levelness throughout a limited working range of the implement and typically make use of linkages to tie the rear lifting components to a front pivoting pull frame. While these designs adequately keep the frame level throughout its working range, they are still often difficult to adjust thereby requiring a tractor operator and a field observer. It is not uncommon for substantial time and effort to be expended to find the optimal setting.

Other attempts at frame leveling include using hydraulic means for control, but such systems are independent of machine depth. As a result, they require additional hydraulic control circuits and operator skill and attentiveness in properly adjusting the mechanism. Further, such systems are not automatic and require independent adjustment.

More recently, hydraulic depth valves have become widely used on implements to control depth. Typical systems use a mechanically actuated valve that limits downward travel to a preset depth. These systems typically still use a mechanical self-leveling mechanism, which still requires two people for making adjustments. Indicators are common among tillage machines but have typically only been used to indicate implement depth. While depth indicators are important to efficient operation of the implement, depth indicators do not indicate implement levelness.

Therefore, there remains a need for a self-leveling depth setting system that in addition to setting the depth of the tillage implement also maintains implement levelness throughout its vertical range of motion.

### SUMMARY OF THE INVENTION

The present invention provides an operator-controllable system that allows the operator to make initial (and preferably optimal) field operation settings for the towed working tool (“implement”) quickly and easily when hitching the working tool to the towing vehicle, e.g., tractor. Once an initial setup is completed, in operation, the invention, which in one form is a leveling arrangement for the working tool, automatically maintains the optimal operation settings throughout the vertical operational range of the working tool. For example, if the optimal operation settings is a level implement throughout its operating range, the leveling arrangement will maintain the implement level as the implement is raised and lowered.

Therefore, in accordance with one aspect of the invention, a farm implement that is towed by a towing vehicle and that is movable vertically from a working raised position and a working lowered position with the range there-between defining a working operating range for the farm implement includes a main frame to which a plurality of ground engaging tools are mounted. The implement further has a hitch frame that connects the main frame to the towing vehicle and a leveling arrangement connected to the main frame and the hitch frame that continuously maintains the main frame in a substantially level position throughout the working operating range.

In accordance with another aspect of the invention, an improvement for a farm implement having a main frame movable through a vertical range of positions and a hitch frame is provided. The improvement interfaces with a leveling arrangement for maintaining a constant level of the main frame throughout its vertical range of positions. The improvement includes a first hydraulic actuator operative to raise and lower the main frame and a second hydraulic actuator operative to rotate the hitch frame against a hitch of the towing vehicle simultaneously with operation of the first hydraulic actuator to maintain the main frame level throughout the vertical range of positions.

According to a further aspect of the invention, a farming system includes a tractor having a hitch, an implement that is towed by the tractor and that is movable vertically from a raised position and a lowered position with the range there-between defining a working operating range for the implement. The implement has a main frame to which a plurality of ground engaging tools are mounted and a hitch frame that connects to the hitch of the tractor. The implement further has a leveling arrangement connected to the main frame and the hitch frame that continuously maintains the main frame in a substantially level position throughout the working operating range.

Various other features and advantages will be made apparent from the following detailed description and the drawings.

### BRIEF DESCRIPTION OF THE FIGURES

FIG. 1 is a pictorial view of a farming system having a farming implement according to the present invention;

FIG. 2 is a simplified isometric view of the farming implement of the farming system of FIG. 1;

FIG. 3 is a side elevation view of the farming implement of FIG. 2;

FIG. 4A is an enlarged side elevation view of a front portion of the farming implement of FIG. 2;

FIG. 4B is an enlarged side elevation view of a rear portion of the farming implement of FIG. 2

FIG. 5 is a schematic of a hydraulic system for the farming implement of FIG. 2 according to one embodiment of the invention; and

FIG. 6 is a schematic of a hydraulic system for the farming implement of FIG. 2 according to an alternate embodiment of the invention.

### DETAILED DESCRIPTION

Turning now to the figures, a farming system 10 is generally comprised of a farm implement 12 that is hitched to a towing vehicle 14, such as a tractor. In the illustrated embodiment, the farm implement 12 is a tillage machine but the invention is not so limited. The farm implement 12 is generally comprised of a hitch frame 16 and a main frame 18 to which a plurality of ground engaging tools 20 are conventionally attached. The ground engaging tools 20 in the illustrated embodiment include a combination of shanks 22 and coulters 24 but it is understood that other types or other combinations of tools could be used. The hitch frame 16 couples the main frame 18 to the hitch 26 of the towing vehicle 14 in a conventional manner.

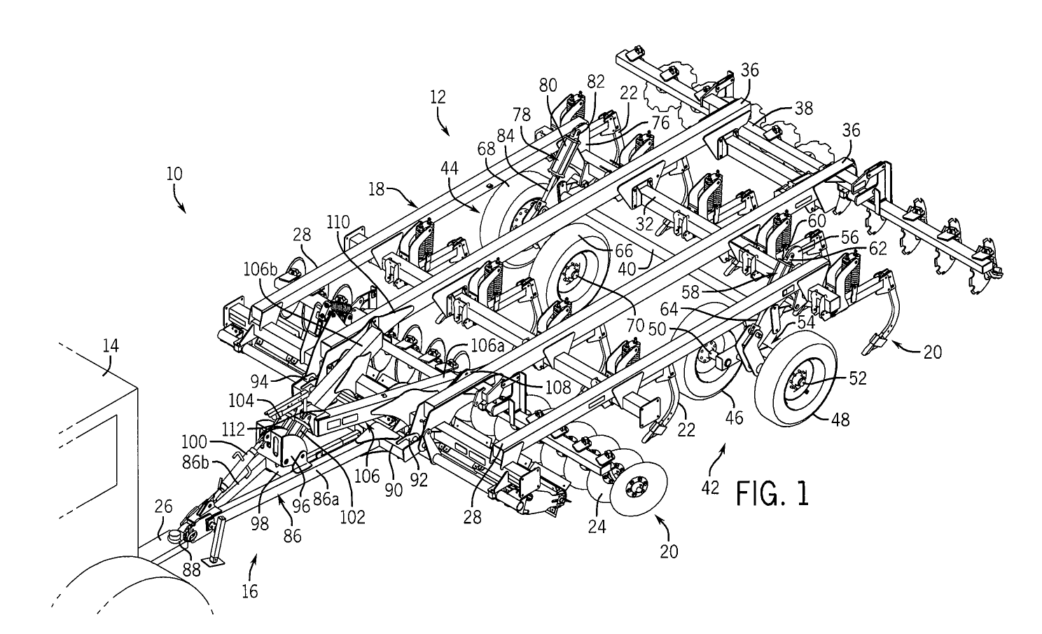

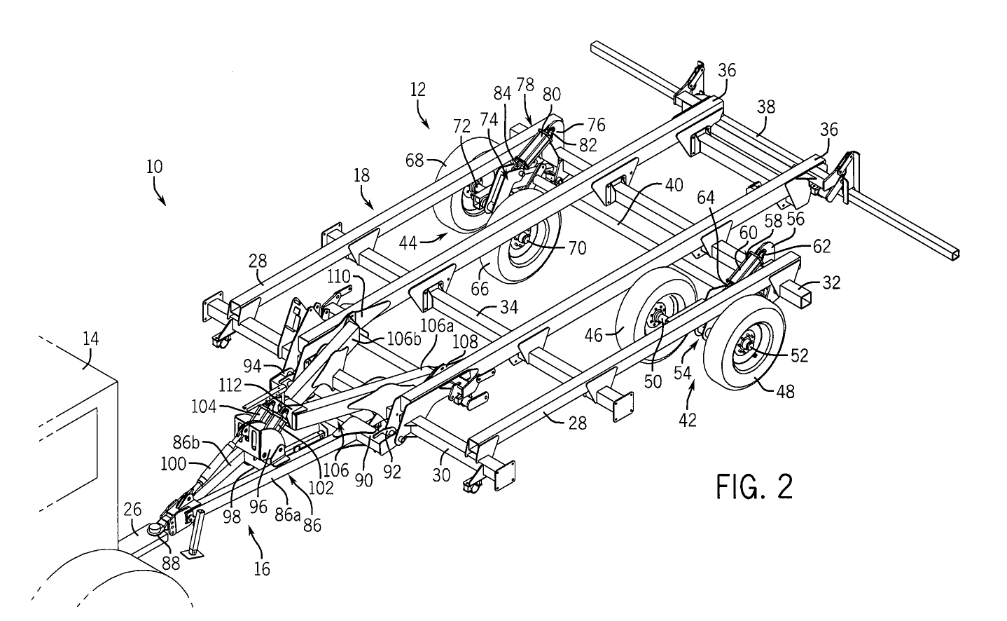

FIG. 2 provides a simplified isometric view of the farm implement 12. In the view of FIG. 2, for purposes of simplification, the ground engaging tools 20 have been removed. From FIG. 2 it will be appreciated that the main frame 18 consists a pair of outer rails 28 extending parallel to one another in a longitudinal direction between a header bar 30 and a footer bar 32. To provide additional stability, the main frame 18 includes an intermediate crossbar 34. In addition to outer rails 28, the main frame 18 also has a pair of inner rails 36 that extend parallel to one another in a longitudinal direction between the header bar 30 and a trailing bar 38 that is spaced rearward (in the fore-aft direction) of the footer bar 32. Working tools, such as harrows (as shown in FIG. 1), may be mounted to the trailing bar 38. The inner rails 36 are positioned inboard of the outer rails 28. The rails and bars are interconnected in a known manner using brackets, weldments, and the like. It will also be appreciated that wing frame sections (not shown) may be mounted to the main frame 18 to provide additional width or coverage of the implement. Preferably, such wing sections are pivotally mounted or otherwise associated with the main frame 18 to allow the implement to fold for transport and storage.

Viewing from the towing vehicle 14 rearward, there is extending transverse to the rails and slightly forward of the footer bar 32 a rod 40 having a first end (not numbered) connected to a first (right) wheel assembly 42 and a second end (not numbered) connected to a second (left) wheel assembly 44. Wheel assembly 42 includes inboard and outboard tires 46, 48, respectively, mounted in a conventional manner to inboard and outboard axles 50, 52, respectively. The axles 50, 52 are both connected to a tire mount 54 that is pivotally connected to a mounting bracket 56 that is connected to the footer bar 32. The tire mount 54 is caused to pivot relative to the mounting bracket 56 by an actuator 58, which in a preferred embodiment, is a hydraulic actuator having barrel 60 connected to the footer bar 32 by flange 62 and an extendible rod 64 connected to the tire mount 54 in a conventional manner. When the rod 64 is extended, the wheel assembly 42 is rotated underneath the main frame 18 to raise the main frame 18. Conversely, when the rod is retracted, the wheel assembly is pivoted away from the footer bar which causes the frame to be lowered.

Wheel assembly 44 also includes inboard and outboard tires 66, 68, respectively, mounted in a conventional manner to inboard and outboard axles 70, 72, respectively. The axles 70, 72 are both connected to tire mount 74 that is pivotally connected to a mounting bracket 76 that is in turn connected to the footer bar 32. The tire mount 74 is caused to pivot relative to the mounting bracket 76 by an actuator 78, which in a preferred embodiment, is a hydraulic actuator having a barrel 80 connected to the footer bar 32 by a flange 82 and an extendible rod 84 connected to the tire mount 74 in a conventional manner. When the rod 84 is extended, the wheel assembly 44 is rotated underneath the main frame 18 to raise the main frame 18. Conversely, when the rod is retracted, the wheel assembly is pivoted away from the footer bar which causes the frame to be lowered.

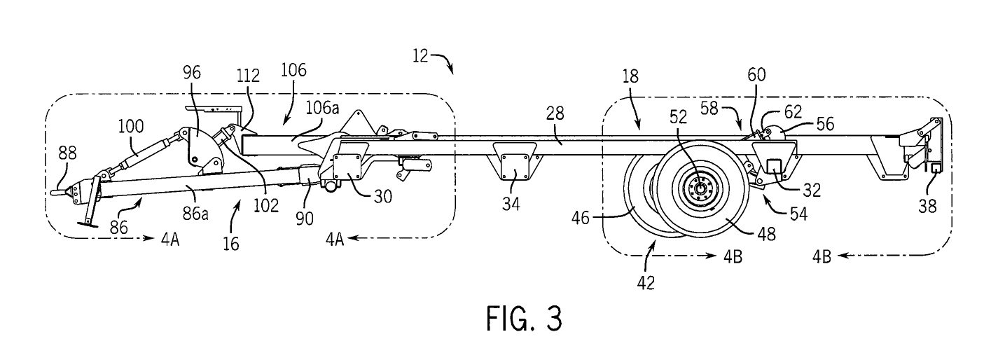

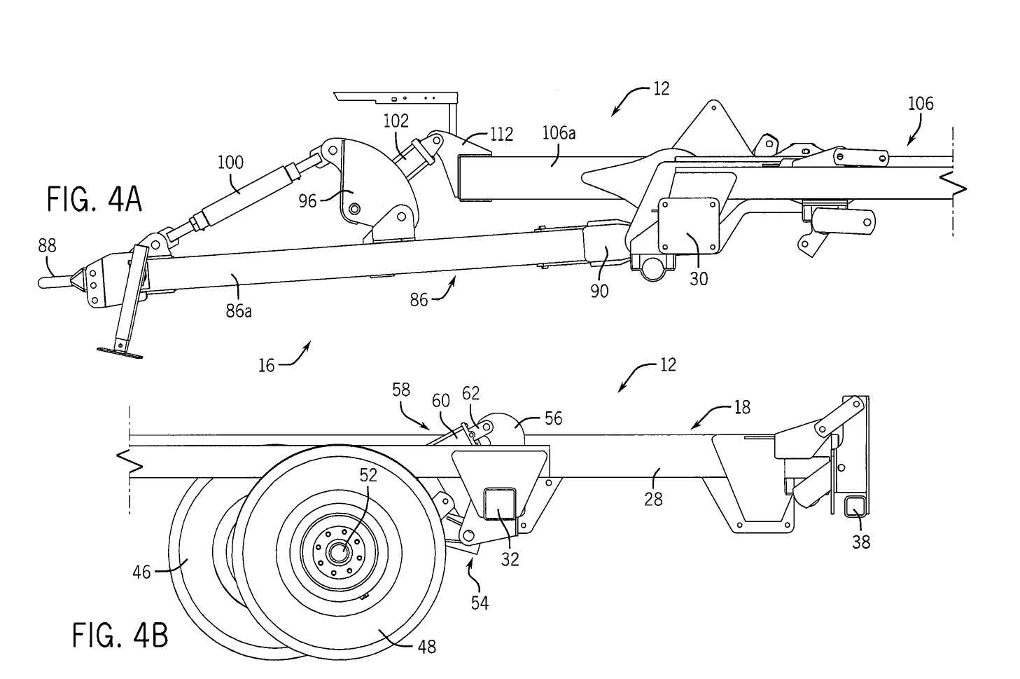

With additional reference to FIGS. 3, 4A, and 4B, the hitch frame 16 consists of an A-frame 86 with a coupler 88 at the point-end of the A-frame 86 for attaching to the hitch 26 (or tow bar) of the towing vehicle 14. The legs 86a, 86b of the A-frame 86 are connected to a shortened cross member 90 that is pivotably connected to the header bar 30 by a pair of pivots 92, 94. A cylinder mount 96 is mounted to the legs 86a, 86b generally above the transverse leg 98 of the A-frame 86. Interconnected between the cylinder mount 96 and the coupler 88 is a turnbuckle 100.

A pair of hydraulic cylinders 102, 104 is interconnected between the cylinder mount 96 and an inverted V-frame 106. The legs 106a, V-frame 106b of the V-frame 106 are attached to the inner rails 36 by brackets 108, 110, respectively. The hydraulic cylinders 102, 104 are pivotally coupled to a bracket 112, which extends from the forward end of the V-frame 106. This pivoting connection allows the cylinders 102, 104 to rotate relative to the V-frame 106, which, as will be described more fully below, allows the outer rails 28 and the inner rails 36 to be kept relatively level as the vertical position of the tractor hitch 26 changes.

The turnbuckle 100 is used for setting the height of the coupler 88 to match the height of the hitch 26 for the towing vehicle 14 pulling the farm implement 12. That is, the towing vehicle 14 and the farm implement 12 are placed in a fore-aft arrangement and on substantially level ground. The turnbuckle 100 is tuned so that the A-frame 86 is pivoted either upward or downward to match the position of the tractor hitch 26. It is contemplated that the turnbuckle 100 may include markings or other indicators to guide an operator in setting the tension in the turnbuckle 100, and thus pivoting the A-frame 86, based on an expected range of tractor hitch positions, e.g., a height range of 15-22″. Once this adjustment has been made for the specific tractor, the turnbuckle 100 does not need to be reset. And, as will be described more fully below, the actuators 58, 78 and hydraulic cylinders 102, 104 will cooperate to maintain the main frame 18 level through a normal operating range. It is contemplated that tuning devices other than the aforedescribed turnbuckle could be used to adjust the height of the coupler 88.

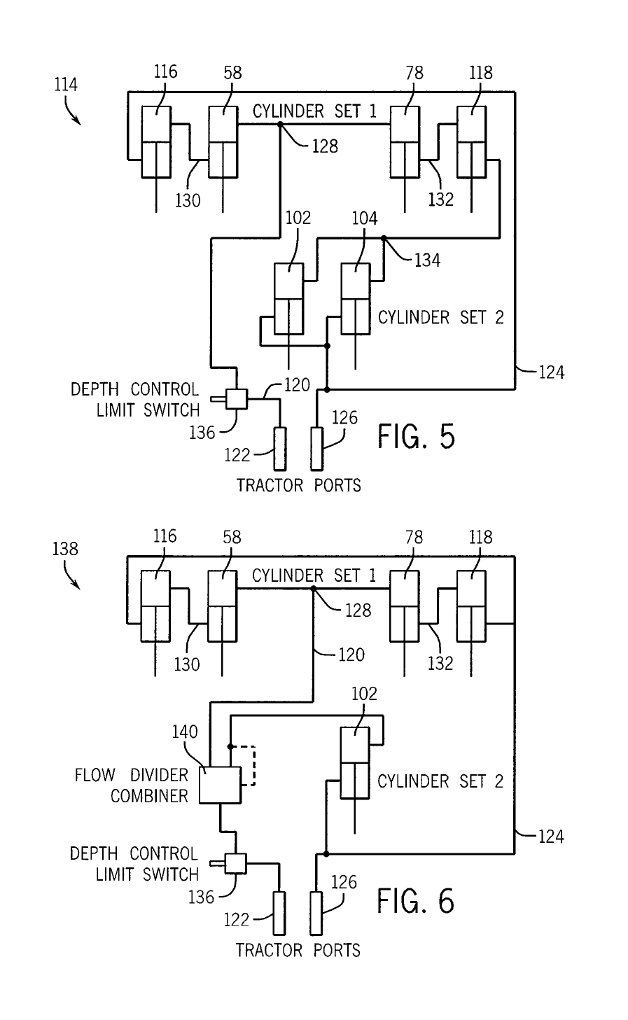

Turning now to FIG. 5, the present invention provides a hydraulic system 114 for use with farm implement 12 or other similar type of farming implement. Farm implement 12 has been described as having a main frame 18 supported by a pair of wheel assemblies 42, 44. As noted above however, it is contemplated that the farm implement 12 may be equipped with left and right wing sections (not shown) that are each supported by one or more wheel assemblies (not shown). The hydraulic system 114 will be described with respect to a farm implement having a main frame and a pair of wing sections, and more particularly, a farm implement having hydraulic cylinders 58, 78 for raising and lowering the main frame 18 and hydraulic cylinders 116, 118 for raising and lowering left and right wing sections, respectively. The hydraulic system 114 further includes hydraulic cylinders 102, 104 which are used to pivot the hitch frame 16 against the tractor hitch 26 to keep the main frame 18 level as the main frame 18 is raised and lowered.

The hydraulic system 114 has a supply line 120 that couples in a conventional manner to the supply port 122 of the towing vehicle 14 and a return line 124 that couples in a conventional manner to the return port 126 of the towing vehicle 14. The supply line 120 supplies hydraulic fluid to cylinders 58, 78 through a diverter 128. Cylinders 58 and 116 are connected in series such that hydraulic fluid flows from the supply line 120 first through cylinder 58 and then to cylinder 116 through connecting line 130. In a similar manner, cylinders 78 and 118 are connected in series such that hydraulic fluid from the supply line 120 first through cylinder 78 and then to cylinder 118 through connecting line 132.

In the illustrated embodiment, the hydraulic fluid from cylinder 116 dumps directly into the return line 124 whereas hydraulic fluid from cylinder 118 flows through a diverter 134 to supply hydraulic fluid to cylinders 102 and 104. Hydraulic fluid from both cylinders 102, 104 dumps into the return line 124. It will thus be appreciated that cylinders 58, 78, 102, 104, 116, and 118 are plumbed together. The volumes of the cylinders are specifically coordinated such that the extension rates of the cylinder rods will cause the implement frame (main frame and wing sections) to raise (or lower) equally thereby keeping the frames level as they are raised (or lowered).

The hydraulic system 114 further has a depth control limit switch 136 plumbed between the supply line 120 and wheel assemblies' cylinders, e.g., cylinders 58 and 78. The depth control limit switch 136 is utilized to top frame movement at any point in the operational range, thereby allowing an operator to set the depth of tillage. That is, the depth control limit switch 136 stops movement of the frames in the downward direction such that the maximum implement depth desired may be set prior to tillage with the implement fully adjustable above this depth.

Turning now to FIG. 6, a hydraulic system 138 according to another embodiment of the invention is shown. In this embodiment, a flow divider 140 is used to provide the correct ratio of hydraulic flow to the cylinders. Also, in this embodiment, cylinder 118 dumps into the return line 124 rather than cylinders 102, 104. It will further be seen that in this embodiment, a single, rather than two, hydraulic cylinders are used to pivot the hitch frame 16 relative to the tractor hitch 26. The invention is not so limited however. From FIG. 6, it will be appreciated the hydraulic fluid flows to both “sets” of cylinders, e.g., lift cylinders 58, 78, 116, 118 and hitch frame cylinder 102, through the flow divider 140 rather than between the sets of cylinders.

From the foregoing, it will be appreciated that the crop residue and soil-conditioning machine of the present invention simplifies initial machine field operation settings. First, the mechanical turnbuckle provides quick and easy adjustment with an indicator showing the positions for draw bar heights from 15-22″. Once this adjustment has been made for the specific tractor used for towing, the turnbuckle need never be changed and the combination of the transport design and hydraulic circuit self levels the implement.

To set the main depth of the implement, there is a single point depth control (not shown) located conveniently on the leveling frame for easy operator access, e.g., connected to V-frame 106 and rod 40 with a crank handle (not shown) mounted adjacent bracket 112, on the same side of the tractor as the cab door to minimize distance. By setting this prior to heading to the field, the operator can choose to focus on other operational concerns, while being able to hydraulically raise the machine from the cab. As any of these hydraulic adjustments are made, the self-leveling hydraulic circuit compensates to maintain levelness.

The hydraulic self-leveling system enables the operator to make “on the go” fine tuning adjustment to the depth of each component on the machine. In an alternate embodiment of the invention, two hydraulic switches—one at the front of the machine attached to the self-leveling component and the other controlling hydraulic fluid flow to the lift cylinders—could be used rather than a flow divider.

While the invention has been described in terms of various specific embodiments, those skilled in the art will recognize that the invention can be practiced with modification within the spirit and scope of the claims.

1. A farm implement that is towed by a towing vehicle and that is movable vertically from a working raised position and a working lowered position with the range there-between defining a working operating range for the farm implement, comprising:
a main frame for supporting a plurality of ground engaging tools;
a hitch frame that connects the main frame to the towing vehicle;
a leveling arrangement connected to the main frame and the hitch frame that pivots the hitch frame against the towing vehicle to continuously maintain the main frame in a substantially level position throughout the working operating range; and
a limit switch in communication with the leveling arrangement, the limit switch including a user-adjustable maximal depth setting for the main frame for allowing a user to set a maximum lowered position for the main frame at any point in the working operating range.

2. The farm implement of claim 1 further comprising a support wheel pivotably coupled to the main frame, and wherein the leveling arrangement includes a first actuator interconnected to the hitch frame and the main frame and a second actuator connecting the support wheel to the main frame.

3. The farm implement of claim 2 further comprising a turnbuckle assembly interconnected to the hitch frame and the first actuator.

4. The farm implement of claim 3 wherein the turnbuckle assembly comprises a turnbuckle and a mounting arm, wherein the turnbuckle has a first end connected to the hitch frame and a second connected to a first end of the mounting arm, and wherein the mounting arm has a second end connected to the hitch frame, and wherein the first actuator is connected to the first end of the mounting arm and the main frame.

5. The farm implement of claim 2 wherein the first actuator includes a first set of hydraulic cylinders and the second actuator includes a second set of hydraulic cylinders.

6. The farm implement of claim 5 wherein the first set of hydraulic cylinders includes more than one hydraulic cylinder and the second set of hydraulic cylinders includes more than one hydraulic cylinder.

7. The farm implement of claim 5 wherein the first set of hydraulic cylinders and the second set of hydraulic cylinders are plumbed together.

8. (canceled)

9. The farm implement of claim 7 wherein the limit switch is plumbed with the first and the second sets of hydraulic cylinders.

10. The farm implement of claim 9 further comprising a hydraulic flow divider that provides a ratio flow of hydraulic fluid to the first and the second set of hydraulic cylinders.

11. For a farm implement having a main frame movable through a vertical range of positions and a hitch frame, the hitch frame for coupling the main frame to a towing vehicle, a plurality of ground engaging tools mounted to the main frame, and at least one wheel for supporting the main frame above the ground, a leveling arrangement for maintaining a constant level of the main frame throughout its vertical range of positions, the improvement comprising:
a first hydraulic actuator operative to raise and lower the main frame;
a second hydraulic actuator operative to rotate the hitch frame against a hitch of the towing vehicle simultaneously with operation of the first hydraulic actuator to maintain the main frame level throughout the vertical range of positions; and
a limit switch;
wherein:
the first hydraulic actuator includes more than one hydraulic cylinder and the second hydraulic actuator includes more than one hydraulic cylinder;
the hydraulic cylinders for the first and the second hydraulic actuator are plumbed together; and
the limit switch plumbed with the hydraulic cylinders and operative to allow a user to set a maximum lowered position for the main frame along the vertical range of positions.

12-14. (canceled)

15. The improvement of claim 11 further comprising a proportional flow valve coupled to the first and the second hydraulic actuators.

16. The improvement of claim 11 further comprising an adjustable turnbuckle for setting a hitch height of the towing vehicle when the implement is on a level surface.

17. A farming system comprising:
a tractor having a hitch;
an implement that is towed by the tractor and that is movable vertically from a raised position and a lowered position with the range there-between defining a working operating range for the implement, the implement including:
a main frame to which a plurality of ground engaging tools are mounted;
a hitch frame that connects to the hitch of the tractor;
a leveling arrangement connected to the main frame and the hitch frame that continuously maintains the main frame in a substantially level position throughout the working operating range; and
a limit switch in communication with the leveling arrangement, the limit switch including a user-adjustable maximal depth setting for the main frame for allowing a user to set a maximum lowered position for the main frame at any point in the working operating range.

18. The farming system of claim 17 further comprising an adjustable turnbuckle for setting a height of the hitch when the implement is on a level surface.

19. The farming system of claim 17 wherein the leveling arrangement includes a first hydraulic actuator operative to raise and lower the main frame and a second hydraulic actuator operative to rotate the hitch frame against the hitch of the tractor simultaneously with operation of the first hydraulic actuator to maintain the main frame level throughout the working operating range.

20. The farming system of claim 19 wherein the leveling arrangement further includes a proportional flow valve to control hydraulic fluid flow to the first and the second hydraulic actuator.
